(19) United States
(12) Patent Application Publication
(10) Pub. No.: US 2006/0170792 A1
(43) Pub. Date: Aug. 3, 2006

(54) System and method for providing true luminance detail

(75) Inventor: Albert D. Edgar, Austin, TX (US)

Correspondence Address: ANDERSON & JANSSON, L.L.P., 9501 N. CAPITAL OF TX HWY. #202, AUSTIN, TX, 78759, US

(73) Assignee: SozoTek, Inc., Austin, TX (US)

(21) Appl. No.: 11/271,435

(22) Filed: Nov. 10, 2005

Related U.S. Application Data
(60) Provisional application No. 60/627,130, filed on Nov. 12, 2004.

(51) Int. Cl. H04N 5/21; H04N 9/77; H04N 9/68

(52) U.S. Cl. 348/234

(57) ABSTRACT

Provided is a system and method for altering luminance characteristics of an image organized according to a transmission protocol for a compressed image. The method includes, but is not limited to, determining a transmission luminance component of the image according to the representation of luminance provided for in the transmission protocol; substituting the transmission luminance component of the image for a reconstruction luminance component; and converting the image with the substituted transmission luminance component into an approximate human perceivable gamma representation.

### CROSS-REFERENCE TO RELATED APPLICATION

This application claims priority from U.S. provisional application of Albert D. Edgar entitled “SYSTEM AND METHOD FOR TRUE LUMINANCE DETAIL” application Ser. No. 60/627,130, filed Nov. 12, 2005, the entire contents of which are fully incorporated by reference herein for all purposes.

### TECHNICAL FIELD

The present application relates generally to the field of image processing.

### BACKGROUND

The luminance of an image or video projection is the visible photometric brightness measured by the amount of light leaving the surface through reflection, transmission or emission. Chrominance can be defined as the difference between a color and a specified reference color having a specified chromaticity and an equal luminance. The relationship between chrominance and luminance is treated differently depending on the type of digital image compression and/or transmission of images and video. The qualities of an image are separated into different channels for transmission. Luminance and chrominance information is typically separated into several channels for transmission. The amount of data dedicated to the image quality can then be segregated among the different channels by dedicating more or less data to the given channels.

In JPEG, NTSC TV and PAL TV, the luminance channel of an image is generated with an approximation of 29 percent red, 59 percent green, and 12 percent blue. JPEG images are typically transmitted with very high resolution and high detail. Two color channels are derived as vectors of the image relative to gray, as pure color components.

The color encoding system used for analog television worldwide (NTSC, PAL and SECAM). The YUV color space (color model) differs from RGB, which is what the camera captures and what humans view. When color signals were developed in the 1950s, it was decided to allow black and white TVs to continue to receive and decode monochrome signals, while color sets would decode both monochrome and color signals.

Luma and Color Difference Signals

The Y in YUV stands for “luma,” which is brightness, or lightness, and black and white TVs decode only the Y part of the signal. U and V provide color information and are “color difference” signals of blue minus luma (B−Y) and red minus luma (R−Y). Through a process called “color space conversion,” the video camera converts the RGB data captured by its sensors into either composite analog signals (YUV) or component versions (analog YPbPr or digital YCbCr). For rendering on screen, all these color spaces must be converted back again to RGB by the TV or display system.

Mathematically Equivalent to RGB

YUV also saves transmission bandwidth compared to RGB, because the chroma channels (B−Y and R−Y) carry only half the resolution of the luma. YUV is not compressed RGB; rather, Y, B−Y and R−Y are the mathematical equivalent of RGB.

For example, in JPEG, the U vector is defined as the blue component minus the luminance component. Thus, the U vector is precisely zero for a precisely gray image, depending on the blue or yellow in a particular region of an image. The V vector is the red color minus the luminance. The U and V vectors are set with a lower resolution in JPEG and typically with a much lower number of bits at a lower resolution.

One problem with the typical channel allocations defined by NTSC, PAL, JPEG and MPEG is that the luminance component (29 percent red, 59 percent green and 12 percent blue) is defined in a gray scale assuming that the image is to be held in a computer. For purposes of computer storage, the luminance is stored as the square root of the luminance value, proportionately the square root of the luminance, in the so-called gamma-2 space.

Because the reduction to the luminance component is defined in gamma-2 space, a bright red object or a bright green or a bright blue object will be seen by the computer through the square root equation as being much darker than perceived by the human eye. Thus, to restore the original image to the nascent brightness, the two chrominance components are added in a gamma-2 space correction. There are problems inherent with restoring an original image using the gamma-2 space correction. Namely, the chrominance components are distorted as compared to the original image. The apparent distortions include flaring around edges of red colored areas and noisy appearing images. Embodiments provided herein address the distortions created by the restoration process created for image transmission and compression.

### SUMMARY

A method is provided for altering luminance characteristics of an image organized according to a transmission protocol for a compressed image, the method includes, but is not limited to determining a transmission luminance component of the image according to the representation of luminance provided for in the transmission protocol; substituting the transmission luminance component of the image for a reconstruction luminance component; and converting the image with the substituted transmission luminance component into an approximate human perceivable gamma representation.

One embodiment is directed to a computer program product that is provided for a computer readable medium configured to perform one or more acts for determining a transmission luminance component of the image according to the representation of luminance provided for in the transmission protocol; substituting the transmission luminance component of the image for a reconstructed luminance component; and converting the image with the substituted transmission luminance component into an approximate human perceivable gamma representation.

One embodiment is directed to a computer system or mobile device including, but not limited to a processor; a memory coupled to the processor; an optional digital camera coupled to the computer system/mobile device and an image processing module coupled to the memory, the image processing module including a luminance transmission component configured to reconstruct the image according to the representation of luminance provided for in the transmission protocol, the luminance transmission component providing a reconstructed luminance component; a conversion component configured to convert the image with the substituted transmission luminance component into an approximate human perceivable gamma representation; a ratio component configured to determine a ratio between the approximate human perceivable gamma representation of the reconstructed image and the reconstructed image with substituted transmission luminance component to obtain a correction image; and a multiply component configured to multiply the correction image by the reconstructed image to obtain a luminance corrected image.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject described herein will become apparent in the text set forth herein.

### BRIEF DESCRIPTION OF THE DRAWINGS

A better understanding of the subject matter of the present application can be obtained when the following detailed description of the disclosed embodiments is considered in conjunction with the following drawings, in which:

FIG. 1 is a block diagram of an exemplary computer architecture that supports the claimed subject matter;

FIG. 2 is a block diagram illustrating a computer system/mobile device including an image processing module including embodiments of the present application;

FIGS. 3A and 3B represent a flow diagram illustrating a method in accordance with embodiments of the present application.

FIG. 4 illustrates images representative of results of following the method provided in embodiments of the present application.

### DETAILED DESCRIPTION OF THE DRAWINGS

Those with skill in the computing arts will recognize that the disclosed embodiments have relevance to a wide variety of applications and architectures in addition to those described below. In addition, the functionality of the subject matter of the present application can be implemented in software, hardware, or a combination of software and hardware. The hardware portion can be implemented using specialized logic; the software portion can be stored in a memory or recording medium and executed by a suitable instruction execution system such as a microprocessor.

More particularly, the embodiments herein include methods related to enhancing images transmitted or compressed. The methods provided are appropriate for any digital imaging system wherein images are compressed and/or transmitted using any type of gamma-2 space correction, or alteration of chrominance channels, including images with altered resolutions, JPEG, MPG, NTSC, PAL and DVD images.

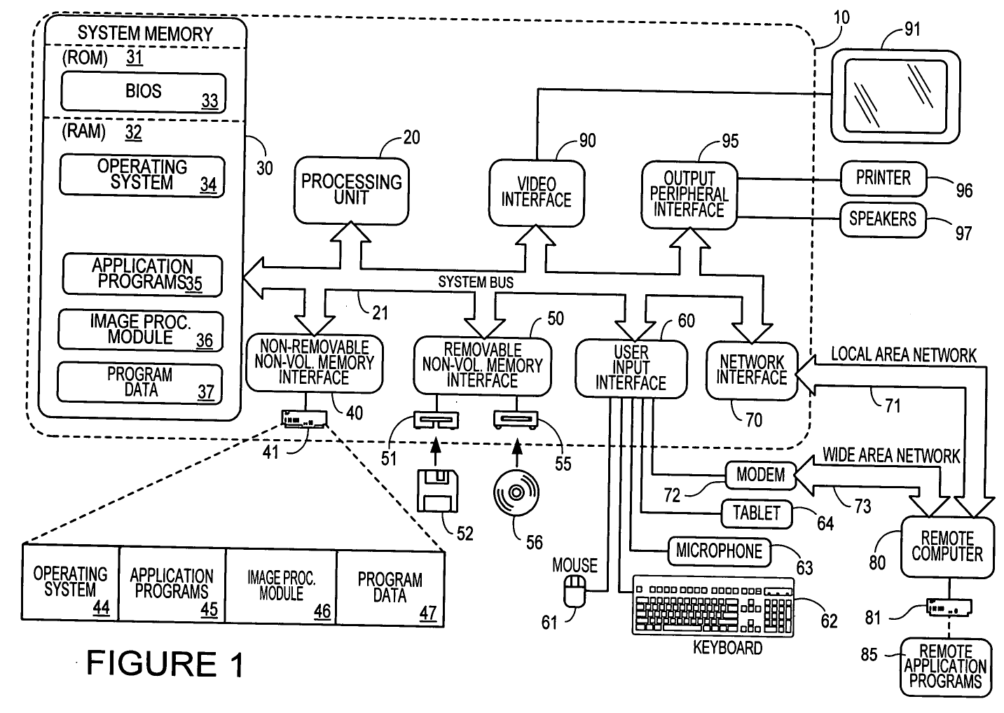

With reference to FIG. 1, an exemplary computing system for implementing the embodiments and includes a general purpose computing device in the form of a computer 10. Components of the computer 10 may include, but are not limited to, a processing unit 20, a system memory 30, and a system bus 21 that couples various system components including the system memory to the processing unit 20. The system bus 21 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 10 typically includes a variety of computer readable media. Computer readable media can be any available media that can be accessed by the computer 10 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 10. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 30 includes computer storage media in the form of volatile and/or nonvolatile memory such as read only memory (ROM) 31 and random access memory (RAM) 32. A basic input/output system 33 (BIOS), containing the basic routines that help to transfer information between elements within computer 10, such as during start-up, is typically stored in ROM 31. RAM 32 typically contains data and/or program modules that are immediately accessible to and/or presently being operated on by processing unit 20. By way of example, and not limitation, FIG. 1 illustrates operating system 34, application programs 35, other program modules 36 and program data 37. FIG. 1 is shown with program modules 36 including an image processing module in accordance with an embodiment as described herein.

The computer 10 may also include other removable/non-removable, volatile/nonvolatile computer storage media. By way of example only, FIG. 1 illustrates a hard disk drive 41 that reads from or writes to non-removable, nonvolatile magnetic media, a magnetic disk drive 51 that reads from or writes to a removable, nonvolatile magnetic disk 52, and an optical disk drive 55 that reads from or writes to a removable, nonvolatile optical disk 56 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 41 is typically connected to the system bus 21 through a non-removable memory interface such as interface 40, and magnetic disk drive 51 and optical disk drive 55 are typically connected to the system bus 21 by a removable memory interface, such as interface 50. An interface for purposes of this disclosure can mean a location on a device for inserting a drive such as hard disk drive 41 in a secured fashion, or a in a more unsecured fashion, such as interface 50. In either case, an interface includes a location for electronically attaching additional parts to the computer 10.

The drives and their associated computer storage media, discussed above and illustrated in FIG. 1, provide storage of computer readable instructions, data structures, program modules and other data for the computer 10. In FIG. 1, for example, hard disk drive 41 is illustrated as storing operating system 44, application programs 45, other program modules, including image processing module 46 and program data 47. Program modules 46 is shown including an image processing module, which can be configured as either located in modules 36 or 46, or both locations, as one with skill in the art will appreciate. More specifically, image processing modules 36 and 46 could be in non-volatile memory in some embodiments wherein such an image processing module runs automatically in an environment, such as in a cellular and/or mobile phone. In other embodiments, image processing modules could be part of a personal system on a hand-held device such as a personal digital assistant (PDA) and exist only in RAM-type memory. Note that these components can either be the same as or different from operating system 34, application programs 35, other program modules, including queuing module 36, and program data 37. Operating system 44, application programs 45, other program modules, including image processing module 46, and program data 47 are given different numbers hereto illustrate that, at a minimum, they are different copies. A user may enter commands and information into the computer 10 through input devices such as a tablet, or electronic digitizer, 64, a microphone 63, a keyboard 62 and pointing device 61, commonly referred to as a mouse, trackball or touch pad. Other input devices (not shown) may include a joystick, game pad, satellite dish, scanner, or the like. These and other input devices are often connected to the processing unit 20 through a user input interface 60 that is coupled to the system bus, but may be connected by other interface and bus structures, such as a parallel port, game port or a universal serial bus (USB). A monitor 91 or other type of display device is also connected to the system bus 21 via an interface, such as a video interface 90. The monitor 91 may also be integrated with a touch-screen panel or the like. Note that the monitor and/or touch screen panel can be physically coupled to a housing in which the computing device 10 is incorporated, such as in a tablet-type personal computer. In addition, computers such as the computing device 10 may also include other peripheral output devices such as speakers 97 and printer 96, which may be connected through an output peripheral interface 95 or the like.

The computer 10 may operate in a networked environment using logical connections to one or more remote computers, which could be other cell phones with a processor or other computers, such as a remote computer 80. The remote computer 80 may be a personal computer, a server, a router, a network PC, PDA, cell phone, a peer device or other common network node, and typically includes many or all of the elements described above relative to the computer 10, although only a memory storage device 81 has been illustrated in FIG. 1. The logical connections depicted in FIG. 1 include a local area network (LAN) 71 and a wide area network (WAN) 73, but may also include other networks. Such networking environments are commonplace in offices, enterprise-wide computer networks, intranets and the Internet. For example, in the subject matter of the present application, the computer system 10 may comprise the source machine from which data is being migrated, and the remote computer 80 may comprise the destination machine. Note however that source and destination machines need not be connected by a network or any other means, but instead, data may be migrated via any media capable of being written by the source platform and read by the destination platform or platforms.

When used in a LAN or WLAN networking environment, the computer 10 is connected to the LAN through a network interface or adapter 70. When used in a WAN networking environment, the computer 10 typically includes a modem 72 or other means for establishing communications over the WAN 73, such as the Internet. The modem 72, which may be internal or external, may be connected to the system bus 21 via the user input interface 60 or other appropriate mechanism. In a networked environment, program modules depicted relative to the computer 10, or portions thereof, may be stored in the remote memory storage device. By way of example, and not limitation, FIG. 1 illustrates remote application programs 85 as residing on memory device 81. It will be appreciated that the network connections shown are exemplary and other means of establishing a communications link between the computers may be used.

In the description that follows, the subject matter of the application will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the subject matter of the application is being described in the foregoing context, it is not meant to be limiting as those of skill in the art will appreciate that some of the acts and operation described hereinafter can also be implemented in hardware.

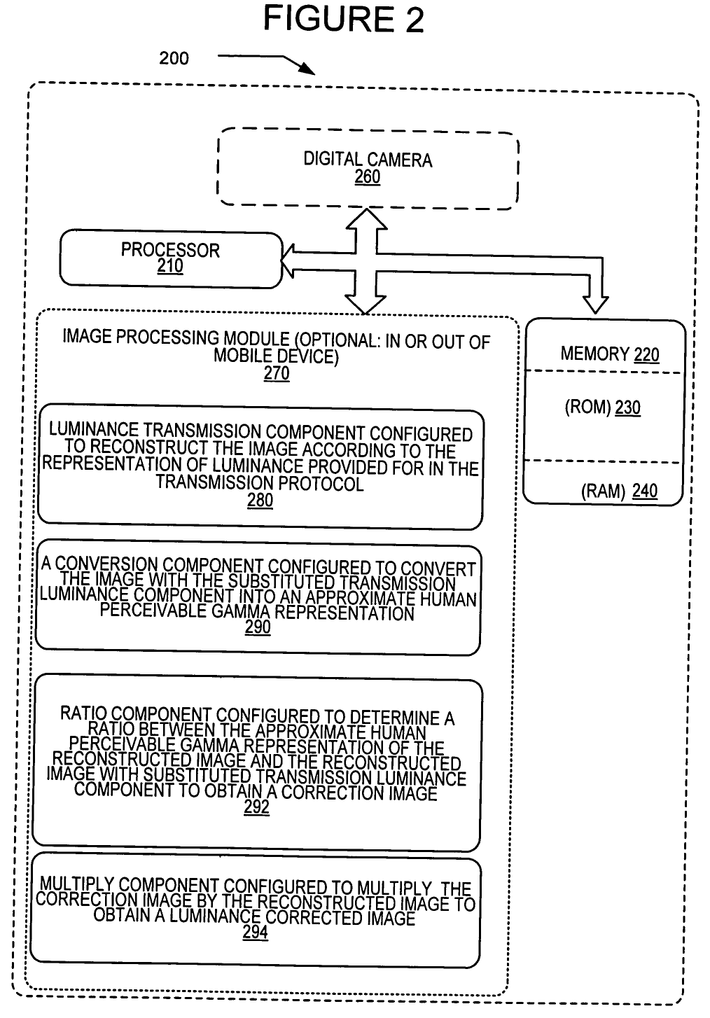

FIG. 1 illustrates program modules 36 and 46 that can be configured to include code for luminance correction. Referring to FIG. 2, a schematic block diagram illustrates how image processing modules included in program modules 36 and 46 can be configured within a mobile device or computer system.

More particularly, FIG. 2 illustrates a processor 210; a memory 220 coupled to the processor, which can include RAM memory 230 and/or ROM memory 240. Also shown is an optional digital camera coupled to the computer system/mobile device 260 and an image processing module 270 coupled to the memory.

Image processing module 270 operates on images that can be collected using a digital camera, or collected using protocols, such as YUV, and JPG that follow the color encoding system used for analog television worldwide (NTSC, PAL and SECAM). The YUV color space differs from RGB, which is what the camera captures and what humans view. When color signals were developed in the 1950s, it was decided to allow black and white TVs to continue to receive and decode monochrome signals, while color sets would decode both monochrome and color signals. The Y in YUV stands for “luma,” which is brightness, or lightness, and black and white TVs decode only the Y part of the signal. U and V provide color information and are “color difference” signals of blue minus luma (B−Y) and red minus luma (R−Y). Through a process called “color space conversion,” the video camera converts the RGB data captured by its sensors into either composite analog signals (YUV) or component versions (analog YPbPr or digital YCbCr). For rendering on screen, all these color spaces must be converted back again to RGB by the TV or display system.

YUV saves transmission bandwidth compared to RGB, because the chroma channels (B−Y and R−Y) carry only half the resolution of the luma. YUV is not compressed RGB; rather, Y, B−Y and R−Y are the mathematical equivalent of RGB. For at least this reason, compression standards use YUV or similar protocols.

To convert from RGB to YUV, one method is to follow the following equations: Y=0.299R+0.587; G+0.114B; U=0.492 (B−Y); and V=0.877 (R−Y).

YUV can also be represented with the following equations: Y=0.299R+0.587G+0.114B; U=−0.147R−0.289G+0.436B; and V=0.615R−0.515G−0.100B.

To convert from YUV to RGB, the following equations can apply: R=Y+1.140V; G=Y−0.395U−0.581V; and B=Y+2.032U.

Referring back to FIG. 2, image processing module 270 includes a luminance transmission component 280 configured to reconstruct the image according to the representation of luminance provided for in the transmission protocol. Luminance transmission component 280 provides a reconstructed luminance component. Image processing module 270 further includes a conversion component 290 configured to convert the image with the substituted transmission luminance component into an approximate human perceivable gamma representation. Image processing module 270 also includes a ratio component 292 configured to determine a ratio between the approximate human perceivable gamma representation of the reconstructed image and the reconstructed image with substituted transmission luminance component to obtain a correction image. Image processing module 270 further includes a multiply component 294 configured to multiply the correction image by the reconstructed image to obtain a luminance corrected image.

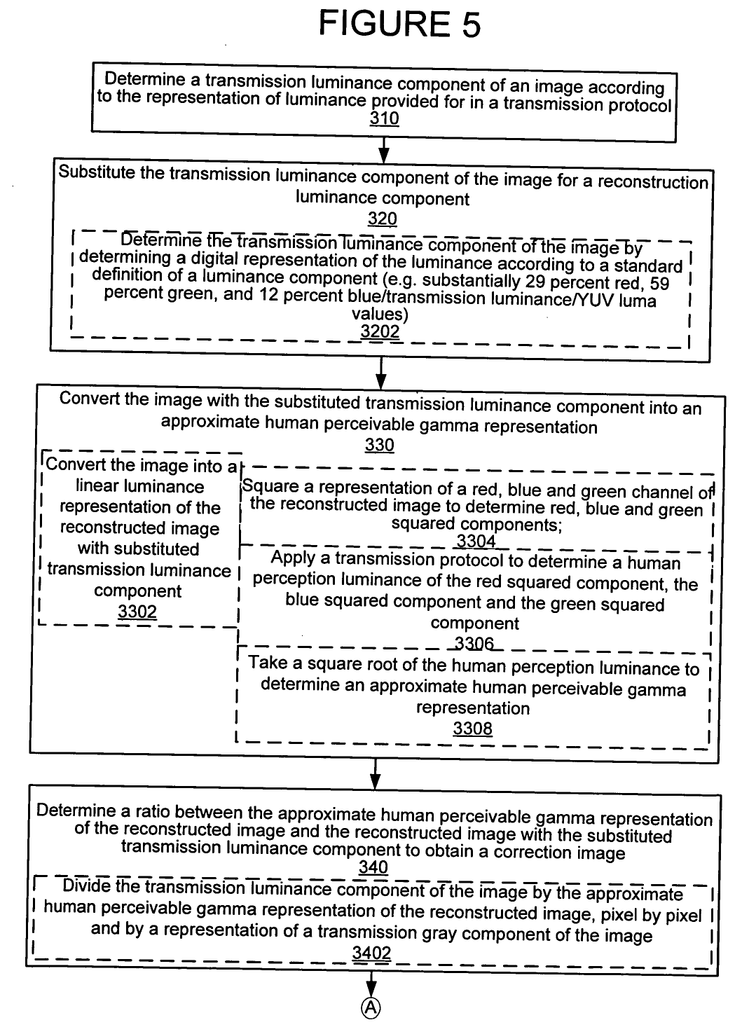

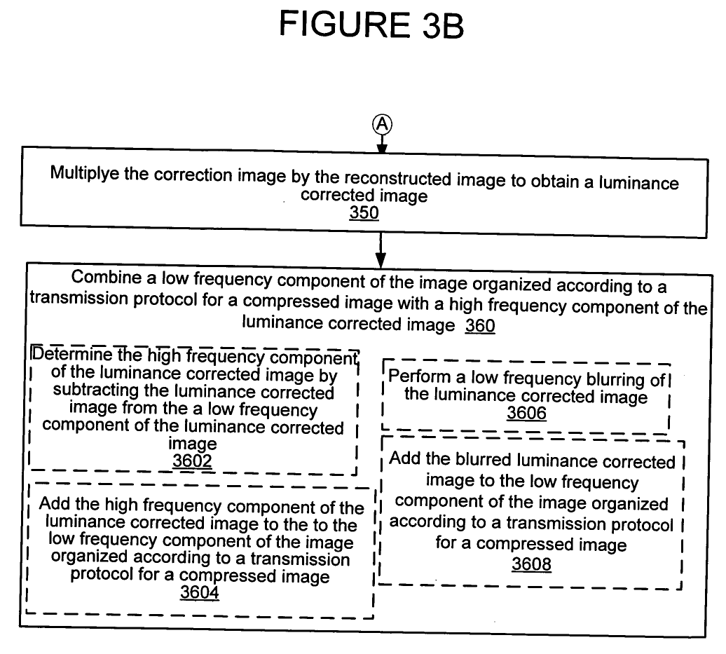

Referring now to FIGS. 3A and 3B, a flow diagram illustrates a method for luminance correction appropriate for embodiments herein. Block 310 provides for determining a transmission luminance component of an image according to the representation of luminance provided for in a transmission protocol. Thus, if the chrominance is set at a lower resolution, as in many JPEG implementations, MPEG, DVDs, NTSC TV and the like, the luminance component will have brightly colored areas that are not perceived as sharp. This leads to red flaring around edges and an image that appears to flare in brightness. Moreover, artifacts in JPEG images can appear crossed over into luminance and will appear with more artifacts because the color channels are set to have more artifacts.

Block 320 provides for substituting the transmission luminance component of the image for a reconstruction luminance component. More particularly, the substitution allows a human eye to see the luminance as transmitted in JPEG, which is a false luminance by a clear view of the image at higher frequencies, substituting this “true” luminance as generated from recomposing the image using the transmitted JPEG at high frequencies and the original color and chroma vectors at lower frequencies allows the eye to perceive a luminance equal to the luminance transmitted. Depicted within block 320 is optional block 3202 which provides for determining the transmission luminance component of the image by determining a digital representation of the luminance according to a standard definition of a luminance component. The recomposition of the image can be performed by regenerating the luminance by taking 29 percent red, 59% green and 12% blue to regenerate the image in gamma 2 space, or the luminance component can be determined before chroma components have been re-added to create an RGB image. Although gamma 2 space is assumed, one of skill in the art will appreciate that gamma 2 is an approximation and that gamma 2.2 can be used, gamma 1.8 can be used depending on system requirements. In an SRGB environment, a gamma 2 approximation can be used with leveling off at a bottom 10% of the grayscale image.

Block 330 provides for converting the image into a linear luminance representation of the reconstructed image with substituted transmission luminance component. The linear luminance space determines what the eye sees as luminance. Thus, deteriming a linear luminance and adding up color vectors as perceived by the eye can produce a linear luminance. One method of providing a linear luminance is to square the red channel, green and blue channels. Once this is done, the three colors can be averaged using 29% of the red squared, 59% of the green squared, and 12% of the blue squared. The percentages can be more precise and follow the protocol used for the image. To return to gamma 2 space, the square root of the result is determined. Depicted within block 330 is optional block 3302, which provides for converting the image into a linear luminance representation of the reconstructed image with substituted transmission luminance component.

The method of determining the linear luminance is shown in FIG. 3, wherein depicted within block 330 are block 3304, 3306 and 3308, which provide a method of converting the image with a substituted transmission luminance component into the approximate human perceivable gamma representation. Block 3304 provides for squaring a representation of a green channel of the reconstructed image to determine a green squared component. Block 3306 provides for applying a transmission protocol to determine a human perception luminance of the red squared component, the blue squared component and the green squared component; and block 3308 provides for taking a square root of the human perception luminance to determine an approximate human perceivable gamma representation. As one of skill in the art will appreciate, instead of squaring the red, blue and green, another function can be used depending on the gamma space chosen.

Block 340 provides for determining a ratio between the approximate human perceivable gamma representation of the reconstructed image and the reconstructed image with the substituted transmission luminance component to obtain a correction image. More particularly, the luminance as transmitted by JPEG or NTXC and the luminance as perceived by the human eye are used to determine the ratio. The image as transmitted divided by the image pixel by pixel divided by the black and white image as perceived by the human eye will provide a correction image. This correction image can be multiplied with the decoded image to present to the human eye an image wherein the human perception sees luminance as transmitted.

Depicted within block 340 is optional block 3402, which provides for dividing the transmission luminance component of the image by the approximate human perceivable gamma representation of the reconstructed image, pixel by pixel and by a representation of a transmission gray component of the image.

Block 350 provides for multiplying the correction image by the reconstructed image to obtain a luminance corrected image. When the correction image is multiplied with the decoded image, the human eye will see an image wherein the human perception sees luminance as transmitted.

Block 360 provides for combining a low frequency component of the image organized according to a transmission protocol for a compressed image with a high frequency component of the luminance corrected image. Depicted within block 360 are block 3602 and block 3604. Block 3602 provides for determining the high frequency component of the luminance corrected image by subtracting the luminance corrected image from the a low frequency component of the luminance corrected image. Block 3604 provides for adding the high frequency component of the luminance corrected image to the to the low frequency component of the image organized according to a transmission protocol for a compressed image.

Block 360 also depicts optional block 3606 and 3608. Block 3606 provides for performing a low frequency blurring of the luminance corrected image. Block 3608 provides for adding the blurred luminance corrected image to the low frequency component of the image organized according to a transmission protocol for a compressed image.

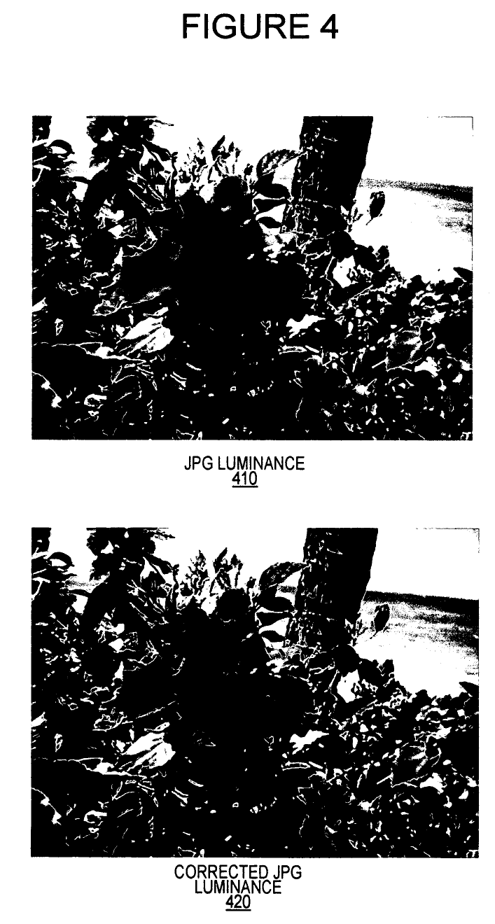

Referring now to FIG. 4, two images are presented, image 410 and image 420, which depict before and after images after the methods according embodiments herein are performed. As shown, image 410 illustrates that few details are visible in brightly colored areas as shown in the center of the image. In comparison, image 420 illustrates that no changes are present in gray areas. In brightly colored areas, such as the center area, the area is darker, artifacts disappear, and more detail is seen. In particular, in areas of bright red, modulation in the green and blue is much more apparent. The increase in detail is important for mobile device images, such as cellular phones. The decrease in artifacts, noise and flaring is apparent.

According to one embodiment, the corrected image can be darker. The darkening is a result of transmission settings. Thus, one method of lightening the image is to take the low frequency component of the original reconstructed image, the complimentary high frequency component of the corrected image and to blur or take the low frequency component of the corrected image. Image 420 illustrates the result of taking high frequencies of the corrected image and adding them to the low frequencies of the uncorrected image. The high and low frequency decomposition can be done multiplicatively. Specifically, the high frequencies of the original corrected image can be generated and divided by low pass frequencies of the corrected image. Thus, a multiplicative high pass image can result. Next, the low pass frequencies of the original received image can be multiplied instead of added to regenerate a reconstituted image.

While the subject matter of the application has been shown and described with reference to particular embodiments thereof, it will be understood by those skilled in the art that the foregoing and other changes in form and detail may be made therein without departing from the spirit and scope of the subject matter of the application, including but not limited to additional, less or modified elements and/or additional, less or modified steps performed in the same or a different order.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

I claim:

1. A method for altering luminance characteristics of an image organized according to a transmission protocol for a compressed image, the method comprising:
determining a transmission luminance component of the image according to the representation of luminance provided for in the transmission protocol; and
substituting the transmission luminance component of the image for a reconstruction luminance component; and
converting the image with the substituted transmission luminance component into an approximate human perceivable gamma representation.

2. The method of claim 1 wherein the substituting the transmission luminance component of the image for a reconstruction luminance component includes:
determining the transmission luminance component of the image by determining a digital representation of the luminance according to a standard definition of a luminance component.

3. The method of claim 2 wherein the determining the transmission luminance component of the image by determining a digital representation of the luminance according to a standard definition of a luminance component includes:
determining the digital representation of the luminance using substantially 29 percent red, 59 percent green, and 12 percent blue.

4. The method of claim 1 wherein the substituting the transmission luminance component of the image for a reconstruction luminance component includes:
determining a luminance component representative of the transmission luminance.

5. The method of claim 4 wherein the determining a luminance component representative of the transmission luminance includes:
determining the luminance component using a Y component of a YUV transmission protocol for color encoding.

6. The method of claim 1 wherein the converting the image with the substituted transmission luminance component into an approximate human perceivable gamma representation includes:
converting the image into a linear luminance representation of the reconstructed image with substituted transmission luminance component.

7. The method of claim 6 wherein converting the image into a linear luminance representation of the reconstructed image with substituted transmission luminance component includes:
squaring a representation of a red channel of the reconstructed image to determine a red squared component;
squaring a representation of a blue channel of the reconstructed image to determine a blue squared component;
squaring a representation of a green channel of the reconstructed image to determine a green squared component;
applying a transmission protocol to determine a human perception luminance of the red squared component, the blue squared component and the green squared component; and
taking a square root of the human perception luminance to determine an approximate human perceivable gamma representation.

8. The method of claim 1 further comprising:
determining a ratio between the approximate human perceivable gamma representation of the reconstructed image and the reconstructed image with the substituted transmission luminance component to obtain a correction image; and
multiplying the correction image by the reconstructed image to obtain a luminance corrected image.

9. The method of claim 8 wherein the determining a ratio between the approximate human perceivable gamma representation of the reconstructed image and the reconstructed image with the substituted transmission luminance component to obtain a correction image includes:
dividing the transmission luminance component of the image by the approximate human perceivable gamma representation of the reconstructed image, pixel by pixel and by a representation of a transmission gray component of the image.

10. The method of claim 8 further comprising:
combining a low frequency component of the image organized according to a transmission protocol for a compressed image with a high frequency component of the luminance corrected image.

11. The method of claim 10 wherein the combining a low frequency component of the image organized according to a transmission protocol for a compressed image with a high frequency component of the luminance corrected image includes:
determining the high frequency component of the luminance corrected image by subtracting the luminance corrected image from the a low frequency component of the luminance corrected image; and
adding the high frequency component of the luminance corrected image to the to the low frequency component of the image organized according to a transmission protocol for a compressed image.

12. The method of claim 10 wherein the combining a low frequency component of the image organized according to a transmission protocol for a compressed image with a high frequency component of the luminance corrected image includes:
performing a low frequency blurring of the luminance corrected image; and
adding the blurred luminance corrected image to the low frequency component of the image organized according to a transmission protocol for a compressed image.

13. The method of claim 1 wherein the transmission protocol is a YUV transmission protocol.

14. The method of claim 1 wherein the transmission protocol determines YUV components by taking percentages of red (R), blue (B) and green (G) values according to Y=0.299R+0.587G+0.114B, U=−0.147R−0.289G+0.436B, and V=0.615R−0.515G−0.100B.

15. The method of claim 1 wherein the transmission protocol determines YUV components by taking percentages of red (R), blue (B) and green (G) values according to Y=0.299R+0.587G+0.114B, U=0.492 (B−Y), and V=0.877 (R−Y).

16. The method of claim 1 wherein the image organized according to a transmission protocol for a compressed image includes one or more of an image transmitted over a wireless network, a cellular network, a computer network, and/or a broadcast network.

17. A computer program product comprising a computer readable medium configured to perform one or more acts for altering luminance characteristics of an image organized according to a transmission protocol for a compressed image, the one or more acts comprising:
one or more instructions for determining a transmission luminance component of the image according to the representation of luminance provided for in the transmission protocol; and
one or more instructions for substituting the transmission luminance component of the image for a reconstruction luminance component; and
one or more instructions for converting the image with the substituted transmission luminance component into an approximate human perceivable gamma representation.

18. The computer program product of claim 17 wherein the acts for substituting the transmission luminance component of the image for a reconstruction luminance component further comprise:
one or more instructions for determining the transmission luminance component of the image by determining a digital representation of the luminance according to a standard definition of a luminance component.

19. The computer program product of claim 18 wherein the determining the transmission luminance component of the image by determining a digital representation of the luminance according to a standard definition of a luminance component includes:
one or more instructions for determining the digital representation of the luminance using substantially 29 percent red, 59 percent green, and 12 percent blue.

20. The computer program product of claim 17 wherein the substituting the transmission luminance component of the image for a reconstruction luminance component includes:
one or more instructions for determining a luminance component representative of the transmission luminance.

21. The computer program product of claim 20 wherein the determining a luminance component representative of the transmission luminance includes
determining the luminance component using a Y component of a YUV transmission protocol for color encoding.

22. The computer program product of claim 17 wherein the converting the image with the substituted transmission luminance component into an approximate human perceivable gamma representation includes:
one or more instructions for converting the image into a linear luminance representation of the reconstructed image with substituted transmission luminance component.

23. The computer program product of claim 22 wherein the one or more instructions for converting the image into a linear luminance representation of the reconstructed image with substituted transmission luminance component includes:
one or more instructions for squaring a representation of a red channel of the reconstructed image to determine a red squared component;
one or more instructions for squaring a representation of a blue channel of the reconstructed image to determine a blue squared component;
one or more instructions for squaring a representation of a green channel of the reconstructed image to determine a green squared component;
one or more instructions for applying a transmission protocol to determine a human perception luminance of the red squared component, the blue squared component and the green squared component; and
one or more instructions for taking a square root of the human perception luminance to determine an approximate human perceivable gamma representation.

24. The computer program product of claim 17 further comprising:
one or more instructions for determining a ratio between the approximate human perceivable gamma representation of the reconstructed image and the reconstructed image with the substituted transmission luminance component to obtain a correction image; and
one or more instructions for multiplying the correction image by the reconstructed image to obtain a luminance corrected image.

25. A computer system comprising:
a processor;
a memory coupled to the processor;
an image processing module coupled to the memory, the image processing module including:
a luminance transmission component configured to reconstruct the image according to the representation of luminance provided for in the transmission protocol;
a conversion component configured to convert the image with the substituted transmission luminance component into an approximate human perceivable gamma representation;
a ratio component configured to determine a ratio between the approximate human perceivable gamma representation of the reconstructed image and the reconstructed image with substituted transmission luminance component to obtain a correction image
a multiply component configured to multiply the correction image by the reconstructed image to obtain a luminance corrected image.

26. The computer system of claim 25 wherein the image processing module is disposed in a mobile device.

27. The computer system of claim 25 wherein the image processing module is configured to receive image data via one or more of a wireless local area network (WLAN), a cellular and/or mobile system, a global positioning system (GPS), a radio frequency system, an infrared system, an IEEE 802.11 system, and a wireless Bluetooth system.

28. The computer system of claim 25 wherein the image processing module is configured to receive image data via one or more of a wireless local area network (WLAN), a cellular and/or mobile system, a global positioning system (GPS), a radio frequency system, an infrared system, an IEEE 802.11 system, and a wireless Bluetooth system.
